(19) United States
(12) Patent Application Publication
(10) Pub. No.: US 2011/0127774 A1
(43) Pub. Date: Jun. 2, 2011

(54) Energy converter for flowing fluids and gases

(75) Inventor: Ludo Jean Maria Mathilde Van Schepdael, Herent (BE)

(73) Assignee: HYDRORING CAPITAL B.V., Den Haag (NL)

(21) Appl. No.: 12/992,274

(22) PCT Filed: May 13, 2009
(86) PCT No.: PCT/NL2009/050252

§ 371 Date: Nov. 15, 2010

(30) Foreign Application Priority Data
May 13, 2008 (NL) 1035410

(51) Int. Cl. H02K 7/18; H02K 7/09

(52) U.S. Cl. 290/52; 310/90.5

(57) ABSTRACT

An electrical machine, e.g. water turbine or bow propeller includes a ring shaped stator ring and inside it a rotatable rotor ring with to it mounted blades flown around by the fluid. Magnetic elements generate axial directed magnetic forces between rotor and stator. Stabilizing elements keep the rotor during operation in an axial stable position. The magnetic elements include permanent magnets to generate an axial directed magnetic preload which is oppositely directed to the force exerted by the water to the rotor ring such that the axial force to be exerted by the stabilization means is smaller. The magnetic elements include the stator and rotor of the generator/motor, wherein the stator and rotor are behind each other, relative to the axial direction.

The invention relates to a machine to convert energy, e.g. a driven ship propeller (wherein also the so called bow propeller for directional control is meant) or a wind or water turbine with generator for generation of energy, e.g. electricity. Preferably this machine has a power in the range of one or a few or tens of Watts and many thousands or even more (e.g. in the range of kilowatt or megawatt). An example is disclosed in DE-A-3 638 129. The invention can be disclosed in an electrical machine (e.g. with a stator and rotor ring) and can also be applied to different fields wherein e.g. two substantially co axial rings rotate relative to each other around a preferably axial axis.

The object is a relatively high circumferential velocity of the rotor relative to the stator of the machine by providing the rotor at a maximised distance to the spinning axis. For that the machine becomes a system as two co axial rings that rotate relative to each other around the axial axis, wherein the rings contain the rotor and stator of the machine. Preferably a so called shaftless machine is obtained, i.e. the bearing of the rotor ring, such as at the hub of a wheel, near its axial spinning axis is absent. And the in co operation with the driving or driven fluid operating blades (e.g. propeller- or turbine blades) preferably extend from the rotor ring in radial direction inwards (substantially comparable to a bicycle wheel wherein the spokes are replaced by the blades and the rim provides the rotor). These blades are preferably at least partly supported by the rotor ring and move preferably along with the rotor ring and turn around the axial axis.

An example of such a machine can be found in the European patent, nr. 1 051 569 (Patentee: HydroRing B.V.). This disclosure offers further technical background for the invention, and its complete disclosure is incorporated in here by reference. Particularly this document discloses keeping the rotor ring in a desired position relative to the stator ring without the use of mechanical bearings, i.e. free of bearings or in other words floating journalling by making use of electromagnets of which the provided magnetic force is controlled by a control unit receiving signals from sensors which detect the position of the rotor ring relative to the stator ring. Thus a floating active journalling/positioning is provided such that the rotor ring turns around its axial axis with the least friction.

The invention particularly relates to a machine with preferably a high power capacity and preferably equipped with one or more of: a ring shaped stator ring, a ring shaped rotor ring turning inside or outside said stator ring; at least one blade mounted to said rotor ring and driving the fluid, such as liquid or gas (e.g. environmental air or water) or driven by it; magnetic means generating magnetic forces between the rotor ring and the stator ring, e.g. to aid in mutually located them in a predetermined position; means to detect a event which influences the position of at least a part of the rotor ring relative to the stator ring; means to control at least a part of the magnetic forces of the magnetic means, e.g. in dependence from the detection by the detection means to keep the rotor ring in a stable position relative to the stator ring; means, like a motor, to drive the rotor ring in rotation relative to the stator ring (the blade drives the fluid like the bow propeller application) and/or means, such as a generator, to take energy from the rotation of the rotor ring relative to the stator ring (the blade is driven by the fluid, like the generator application). Preferably the magnetic means generate attracting and/or repelling magnetic forces between the rotor ring and the stator ring, e.g. to keep the rotor ring in a stable position relative to the stator ring. The magnetic forces preferably provide in that case that the shape stability of the stator ring and/or rotor ring is improved, preferably at least 10%, 20% or 25%.

The magnetic forces can be controlled by supplying more or less energy to the magnets. Alternatively the distance is changed between two magnets or between a magnet and an element attracted by it.

Thus preferably a magnetic field is used to at least partly journal (preferably axially and/or radially), or differently spoken during operation maintain the desired position or stability, respectively, of the rotor ring relative to the stator ring while the rotor ring turns around its axial axis with the least friction. Also from a magnetic field stemming magnetic forces are preferably used to improve during operation the static and/or dynamic stability of a rotor and/or stator ring, wherein e.g. the rotor and/or stator ring are mechanically stiffened, which offers many advantages, like the rotor and/or stator ring can have a light weight structure (e.g. of plastic, e.g. polymer material, possibly fibre reinforced, containing). Adding stability can in the radial and/or axial direction of the rotor or stator ring. A lower limit is that the contribution of the magnetic field to the stability is clear or advantageous.

Preferably due to said magnetic field the stability, e.g. flexural stiffness or shape stability of the rotor ring and/or stator ring increases with at least 10%, more preferably at least 20%, most preferably at least 25%. It is convenient if the rotor ring and/or stator ring are as flexible as possible, such that its stability is almost completely determined by the magnetic field. Since blades (if applied) or different to the rotor ring mechanically fixed parts (if used) can contribute to the stability in one or both directions, it is expected that the magnetic field offers the most advantages when stabilising in the direction which is not stabilised by said blades.

In practise the diameter of the rotor ring and the stator ring can be large compared to the dimensions of the cross section of the rotor ring, e.g. wherein the diameter measures at least 3 times the axial dimension, preferably approximately at least 10 times the axial dimension of the rotor ring, such that a rotor ring is provided with a fairly unstable shape such that further stabilisation is required for long term economical use. On the other hand the rotor ring can be unstable at small ratios of the diameter/axial dimension if e.g. made of plastic material.

Of the components (e.g. two magnets or a magnet and an element attracted by it) which cooperate to generate magnetic forces acting there between, the one is present at the rotor ring and the other at the stator ring.

The inventor came to the conclusion that floating journalling/positioning of the rotor ring by means of controlled electromagnets requires relatively much energy, such that the efficiency of the machine suffers. Not only substantial energy loss is created since the electromagnets have to provide magnetic forces (e.g. 10% of the net power of the machine), also a fast acting control of the electromagnets is required (e.g. position sensors are required which must react within milliseconds).

This problem could according to the inventor partly or completely be solved by compensating at least a part of the by the environment at the rotor ring acting forces at least partly by preloads from one or more permanent magnets which can be mounted fixedly or displacably and co operate with another magnet or a element attracted by it, which other magnet or element can be fixedly or displacably mounted. Because of the displacable mounting the mutual distance between the mutually co operating components can be changed, and with that the magnetic force generated by it. For the displacement the provision is made of displacement means which are connected to control means.

The forces acting by the environment onto the rotor ring are particularly the in axial direction active forces from the fluid driving the rotor are driven by it and the gravity force which is e.g. active in a direction normal to the axial direction if the machine is installed such that the axial direction extends horizontally.

A further energy saving can be obtained by in a further development of the invention mechanically journalling the rotor ring relative to the stator ring. By the magnetic preload one can provide that the mechanical bearing is low loaded, such that friction losses stay small. A further advantage of the mechanical bearing is the robustness; if the magnetic force vanishes the mechanical bearing maintains the position of the rotor ring, while in case of an axial floating bearing in such case the rotor ring immediately looses position and can thus be damaged or causes damage.

Within this invention three basic design for the axial positioning are feasible: (1) wherein the rotor ring is journalled to axially float by means of permanent electromagnets of which the power is controlled; (2) wherein the rotor ring is axially journalled by permanent magnets and mechanical journals; (3) wherein the rotor ring is journalled axially by permanent magnets, electromagnets of which the power is controlled and mechanical bearing.

According to the invention electromagnets could be even absent. If electromagnets are applied it could be in relation with the invention be sufficient if they are controlled by a relatively slow operating control (e.g. with a reaction time of a second or more), particularly in combination with a mechanical bearing. It has come out that the additional friction losses in the mechanical bearing by the slowness of the control of the electromagnets in general are sufficient small in duration such that the because of this caused losses are acceptable compared to the losses that would be caused when a fast control of the electromagnets is applied (such as required by a machine based on EP 1 051 569).

It is preferred to generate with the by the rotor ring driven electrical generator or the the rotor ring driving electromotor, respectively, axially directed magnetic forces, more preferably substantially exclusively axially directed magnetic forces. The generator or motor, respectively, is preferably asymmetrically designed, such that a resulting axial magnetic force is generated by it, which can be used a magnetic preload. E.g. the permanent magnets at the rotor at the one axial side are located closer to the spoel cores of the stator compared to the other axial side, or merely at one axial side of the rotor coil cores of the stator are located. This is further exemplified by the on the drawing based description.

E.g. can the rotor in the direction normal to the axial direction or the radial direction, respectively, be journalled by forces coming from mechanical bearings and/or permanent magnets (compensation of e.g. gravity force). The forces from the environment which in this direction act on the rotor ring will generally not fluctuate such that a variation of the bearing forces, e.g. magnetic forces, in this direction is not required.

The permanent magnets provided to generate magnetic forces in the axial direction and/or the direction normal to it/radial direction can be e.g. located in the Halbach-configuration, such that the magnetic forces are as much as possible concentrated at the one side of the magnets, which side is preferably facing to the ring onto which the magnetic forces must act.

Thus the magnetic bearing is preferably operative to at least partly decrease the load on the mechanical bearing, such that the mechanical bearing cause the least energy loss due to friction.

The mechanical bearing can be of any feasible type, e.g. comprise roller bearings or needle bearings. Most preferable is a slide bearing, preferably designed with slide faces with low coefficient of friction, such as Teflon (PTFE) or ceramic material. Application of water lubrication for the bearings is preferred.

With a mechanical bearing the play in the journals will generally be less than 1.5 or less than 0.5 millimetre. When a mechanical bearing is absent the play between a component of the rotor ring and stator ring will be at least 1.5 or at least 2.0 millimetre.

Now the invention is illustrated by way of embodiments.

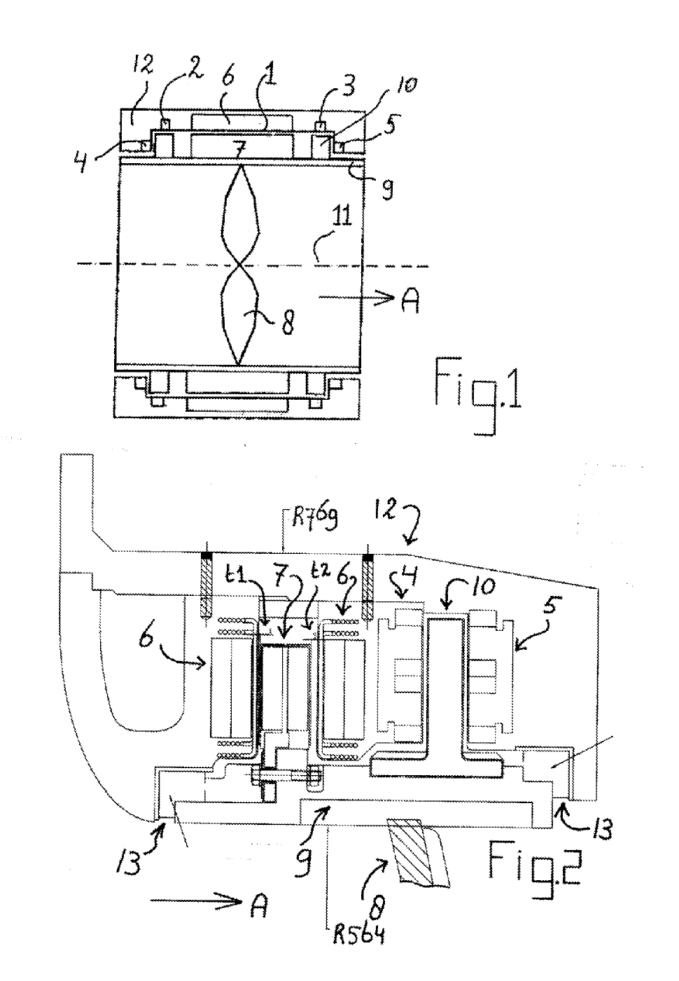

FIG. 1 shows a sectional side view of a principle example.

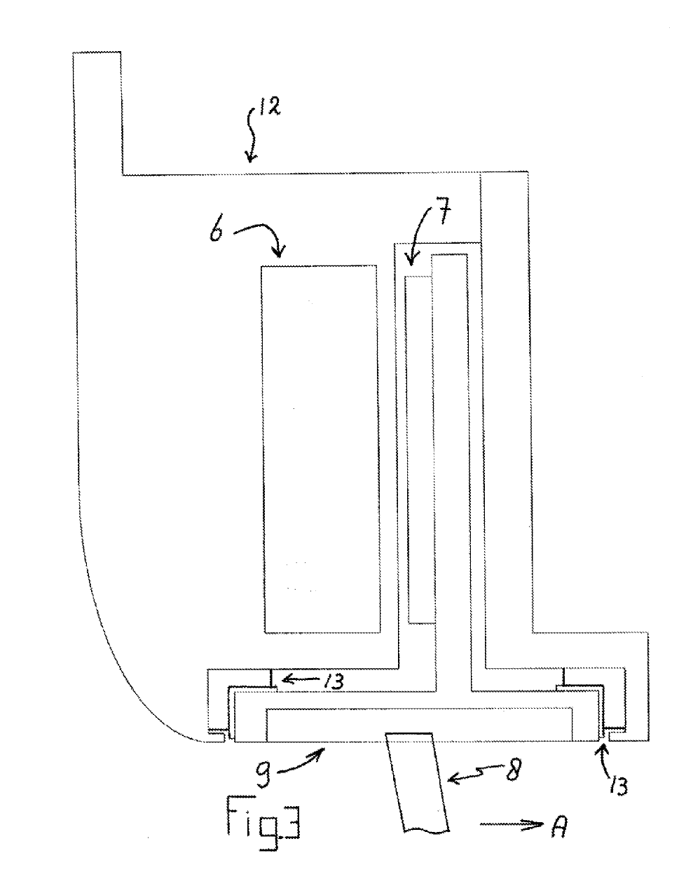

FIG. 2-4 each show a sectional side view of a part of each time a different water turbine according to the invention.

FIG. 1 shows schematically a machine of the invention. A rotor ring 9 rotates within a stator ring 12. The propeller 8 drives the through the motor flowing fluid or is driven by said fluid. The blades of the propeller 8 are mechanically coupled with the stator ring 9 and extend from the rotor ring 9 (radially) inwards, towards the parallel to the axial direction extending spinning axis 11 of the ring 9. The ends of the blades facing away from the propeller 8 mutually merge or end at a mutual distance and have no additional bearing. Thus the blades are exclusively at their to the rotor ring 9 facing ends journalled. The fluid flows according to the arrow A through the machine which is e.g. completely submerged in the fluid.

The rotor ring 9 has a rotor 7 of an electrical machine and anchors 10 of magnetic means. The stator ring has electromagnets 2, 3, 4, 5 of magnetic means, connected to control means (not shown) and co operating with the anchors 10 to provide axial and/or radial forces to control the axial and radial, respectively, position of the rotor ring 9 relative to the stator ring 12. The stator ring 12 comprises the stator 6 of the electrical machine. Between stator 6 and rotor 7 there is a gap with a magnetic field of the electrical machine.

Radial forces and weak axial forces are provided by parts of the magnetic circuits 2 and 3. Axial forces and weak radial forces are provided by parts of the magnetic circuits 4 and 5. The magnetic field in the gap 1 can generate radial forces if the rotor ring is not exactly centred relative to the stator ring, or accidentally, if the flows within the stator and rotor of the electrical machine azimuthally are not equally spread.

Thus the illustrated machine has no journalled, with the main axis (axial axis 11) covering, central physical axis and the blades 8 are merely journalled by the rotor ring 9 which is only magnetically journalled within the stator ring 11. Further embodiments are feasible, e.g. wherein the elements 7 and 10 do not project into the stator ring 12, such that elements 4 and 5 e.g. do not project out ring 12. Also elements 2, 3, 4 and 5 can be completely or partly be changed with respective elements 10. Or the magnetic means are provided by merely the stator 6 and the rotor 7 of the electrical machine.

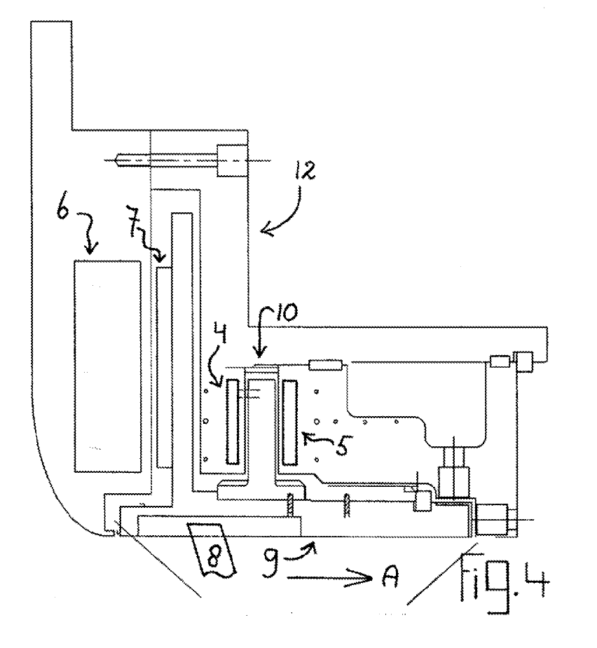

FIG. 2-4 are each taken at an arbitrary position along the circumference of the rotor ring and show in detail how the stator and rotor ring mutually fit, wherein a small piece of a with the rotor ring integrated blade 8 is shown. Shown for FIG. 2-3 are the bearing blocks 13 of which the slide faces both in radial and axial direction have a for these bearings typical play of e.g. 0.5 millimetre. In the embodiment of FIG. 4 a mechanical bearing is absent and between the rotor and stator ring a play of approximately 2 millimetre in both axial and radial direction is present.

In FIG. 2 the windings are shown of the coils belonging to the stator 6 to obtain electrical energy from turning of the rotor 7. These are wound around also to the stator belonging iron cores 10 (anchors) at both sides of a gap in which are present the permanent and in a fixed position mounted magnets of the part of the generator belonging to the rotor 7. These magnets keep to the iron cores to the left of it a distance t1 of e.g. 1 millimetre and to the right of it a (relative to t1 different, e.g. larger or smaller) distance t2 of e.g. 5 millimetre. Thus these magnets provide a to the left directed resulting, constant preload, opposite the to the right through the machine flowing water (arrow A). By removing the iron cores to the right of these magnets, this preload can be enlarged.

To the right of the generator 6, 7 in FIG. 2 there are some sets of to the stator ring 12 in a fixed position mounted electromagnets 4, 5 at both sides of a gap inside which a to the rotor ring 9 mounted iron core 10 is present. Through a control unit with a the water force onto the machine detecting sensor the energy supply to these electromagnets 4, 5 is controlled to minimize the axial load of the mechanical bearings 13.

E.g. the by the generator provided axial preload is such that it 80% or 100% of the nominal axial force of the water flow onto the blades of the rotor counteracts. E.g. the machine can be designed such that from e.g. 30% of the nominal speed of the water flow through to machine, the water flow overrules the friction (static or dynamic) in the mechanical bearings such that the rotor ring starts turning and the generator generates electrical power. This generated power can be used to supply the electromagnets to lower the friction in the mechanical bearings such that more net power is generated. E.g. at a fluid velocity below the required velocity to equal the by the generator provided preload (generally below the nominal speed) the electromagnets have to exert an axial force in the direction of fluid flow of the water while at a velocity above said required velocity (generally above the nominal speed), the electromagnets have to provide a force opposite the fluid flow direction to unload the mechanical bearings.

In stead the generator exerts axial preload, one can provide that by a separate set of permanent magnets and magnetically co operating components.

FIG. 3 shows an embodiment based on FIG. 2 with as most important modification compared to FIG. 2 that electromagnets are removed and the set of iron cores and coils of the to the stator 6 mounted part of the generator are present at merely the upstream side of the permanent magnets of the to the rotor 7 mounted part of the generator. Thus the generator provides the axial magnetic preload which is directed opposite to the water flow through the machine. Since electromagnets are absent this preload can during operation not be varied and is thus constant.

FIG. 4 uses the generator of the type of FIG. 3, and above that electromagnets 4, 5 and anchor 10 with control to during operation vary the axial magnetic preload, the play between rotor and stator ring measures approximately 2 millimetre and a mechanical bearing 13 is absent. The control of the electromagnets must react sufficient quick to changes in the water flow (in less than 0.1 second) to floating journal the rotor ring 9 with the aid of the electromagnets 4, 5 relative to the stator ring 12 and prevent the occurrence of mechanical contact between the turning rotor ring and stationary stator ring during operation.

The invention also covers all other combinations form at least two of the in the description, drawing and/or claims disclosed measurements.

1-15. (canceled)

16. Water turbine to locate in a flowing water body, such as a river, and with a high power capacity of at least 1000 Watt, comprising: a ring shaped stator ring (12); a ring shaped rotor ring (9) which can rotate within the stator ring, at least one blade (8) mounted to the rotor ring and axially loaded and in rotation driven by through the machine flowing water of the water body; magnetic means to generate axially directed magnetic forces between the rotor ring and the stator ring; stabilising means to keep the rotor ring during operation in an axial stable position relative to the stator ring, CHARACTERISED IN THAT the magnetic means comprise permanent magnets which are designed to generate an axially directed magnetic preload oppositely directed to the force exerted by the water to the rotor ring, such that the by the stabilisation means to be exerted axial force is lowered.

17. Machine according to claim 16, wherein the magnetic means comprise the stator (6) and rotor (7) of the generator.

18. Machine according to claim 16, wherein the stator (6) and the rotor (7) are present behind each other, relative to the axial direction (arrow A).

19. Machine according to claim 16, wherein between the stator (6) and rotor (7) there are at least two gaps (t1, t2) which differ in width such that with that a resulting axial magnetic force can be generated which is directed opposite to the by the water flow exerted axial force.

20. Machine according to claim 16, wherein the magnetic means are designed to exert a preload equal to the force from the water by a fluid flow speed between 60% and 120%, preferably between 70% and 90% of the nominal flow speed and this preload is substantially exerted by the permanent magnets of the stator (6) and rotor (7).

21. Machine according to claim 16, provided with means to during operation change the amount of the preload.

22. Machine according to claim 21, wherein said changing means comprise a control and a with that connected electromagnet and detector, wherein said control is designed to in dependence from the signal of the detector increase or decrease the energy supply to the electromagnet while the detector is designed to respond to a change caused by a change in the water flow through the machine, such as positional change of the rotor ring (9).

23. Machine according to claim 16, provided with a mechanical bearing of the rotor ring relative to the stator ring such that between the rotor ring and stator ring a movement play of at the most 2.0 and more preferably at the most 1.0 millimetre in axial and radial direction is present.

24. Machine according to claim 16, which for the axial positioning of the rotor ring relative to the stator ring is embodied without bearings such that the rotor ring is journalled to axially float by the magnetic means while between the rotor ring and stator ring there is a movement play of at least 1.5 and preferably at least 2.0 millimetre in axial direction.

25. Machine according to claim 16, wherein the control is designed to change the energy supply to the electromagnet in less than 0.1 second after a by the detector detected change in the water flow.

26. Machine according to claim 16, wherein the control is designed to change the energy supply to the electromagnet only after 1 second after a by the detector detected change in the water flow.

27. Machine according to claim 16, wherein displacement means are present to change the distance between two magnets or between a magnet and a by it attracted element, which displacement means are connected to control means.

28. Machine according to claim 16, with means to axially floating journalling of the rotor ring by an assembly of permanent magnets and in force controlled electromagnets.

29. Machine according to claim 16, with means to axially floating journalling of the rotor ring by an assembly of permanent magnets and mechanical bearings.

30. Machine according to claim 16, with means to axially floating journalling of the rotor ring by an assembly of permanent magnets, in force controlled electromagnets and mechanical bearings.

31. Water turbine to locate in a flowing water body, such as a river, and with a high power capacity of at least 1000 Watt, comprising: a ring shaped stator ring (12); a ring shaped rotor ring (9) which can rotate within the stator ring, at least one blade (8) mounted to the rotor ring and axially loaded and in rotation driven by through the machine flowing water of the water body; magnetic means to generate axially directed magnetic forces between the rotor ring and the stator ring; stabilising means to keep the rotor ring during operation in an axial stable position relative to the stator ring, wherein:
the magnetic means comprise permanent magnets which are designed to generate an axially directed magnetic preload oppositely directed to the force exerted by the water to the rotor ring, such that the by the stabilisation means to be exerted axial force is lowered;
the magnetic means comprise the stator (6) and rotor (7) of the generator;
the stator (6) and the rotor (7) are present behind each other, relative to the axial direction (arrow A).
between the stator (6) and rotor (7) there are at least two gaps (t1, t2) which differ in width such that with that a resulting axial magnetic force can be generated which is directed opposite to the by the water flow exerted axial force;
the magnetic means are designed to exert a preload equal to the force from the water by a fluid flow speed between 70% and 90% of the nominal flow speed and this preload is exerted by the permanent magnets of the stator (6) and rotor (7);
means are provided to during operation change the amount of the preload, said changing means comprise a control and a with that connected electromagnet and detector, wherein said control is designed to in dependence from the signal of the detector increase or decrease the energy supply to the electromagnet while the detector is designed to respond to a change caused by a change in the water flow through the machine, such as positional change of the rotor ring (9).
the rotor ring is journalled relative to the stator ring by a mechanical bearing such that between the rotor ring and stator ring a movement play of at the most 1.0 millimetre in axial and radial direction is present;
displacement means are present to change the distance between two magnets or between a magnet and a by it attracted element, which displacement means are connected to control means;
the control is designed to change the energy supply to the electromagnet only after 1 second after a by the detector detected change in the water flow.

32. Machine according to claim 31, with means to axially floating journalling of the rotor ring by an assembly of permanent magnets, in force controlled electromagnets and mechanical bearings.

33. Water turbine to locate in a flowing water body, such as a river, and with a high power capacity of at least 1000 Watt, comprising: a ring shaped stator ring (12); a ring shaped rotor ring (9) which can rotate within the stator ring, at least one blade (8) mounted to the rotor ring and axially loaded and in rotation driven by through the machine flowing water of the water body; magnetic means to generate axially directed magnetic forces between the rotor ring and the stator ring; stabilising means to keep the rotor ring during operation in an axial stable position relative to the stator ring, wherein:
the magnetic means comprise permanent magnets which are designed to generate an axially directed magnetic preload oppositely directed to the force exerted by the water to the rotor ring, such that the by the stabilisation means to be exerted axial force is lowered;
the magnetic means comprise the stator (6) and rotor (7) of the generator;
the stator (6) and the rotor (7) are present behind each other, relative to the axial direction (arrow A).
between the stator (6) and rotor (7) there are at least two gaps (t1, t2) which differ in width such that with that a resulting axial magnetic force can be generated which is directed opposite to the by the water flow exerted axial force;
the magnetic means are designed to exert a preload equal to the force from the water by a fluid flow speed between 70% and 90% of the nominal flow speed and this preload is exerted by the permanent magnets of the stator (6) and rotor (7);
means are provided to during operation change the amount of the preload, said changing means comprise a control and a with that connected electromagnet and detector, wherein said control is designed to in dependence from the signal of the detector increase or decrease the energy supply to the electromagnet while the detector is designed to respond to a change caused by a change in the water flow through the machine, such as positional change of the rotor ring (9).
the rotor ring is journalled relative to the stator ring without bearings such that the rotor ring is journalled to axially float by the magnetic means while between the rotor ring and stator ring there is a movement play of at least 2.0 millimetre in axial direction;
displacement means are present to change the distance between two magnets or between a magnet and a by it attracted element, which displacement means are connected to control means;
the control is designed to change the energy supply to the electromagnet only after 1 second after a by the detector detected change in the water flow.

34. Machine according to claim 33, with means to axially floating journalling of the rotor ring by an assembly of permanent magnets and in force controlled electromagnets.
